(19) United States
(12) Patent Application Publication
(10) Pub. No.: US 2026/0126383 A1
(43) Pub. Date: May 7, 2026

(54) One- and Two-Dimensional Spectral-Spatial Filters

(71) Applicant: United States of America as represented by the Administrator of NASA, Washington, DC (US)

(72) Inventors: Joshua M. Weisberger, Newport News, VA (US); Brett F. Bathel, Newport News, VA (US)

(21) Appl. No.: 18/938,526

(22) Filed: Nov. 6, 2024

(51) Int. Cl. G01N 21/45; G01B 11/25; G02B 27/28; G02B 27/46

(52) U.S. Cl. CPC G01N 21/455; G01B 11/2513; G02B 27/286; G02B 27/46

(57) ABSTRACT

Light is projected through a grid (e.g., a Ronchi ruling having a shortpass and/or a longpass filter lines) and onto a background, where the light is spectrally and spatially filtered by the grid to form an image of the grid by a camera. The light from this projected image is then reflected back onto the same grid, with a polarizing refractor (e.g., a Rochon polarizing prism) imparting a small offset between the projected and reflected light, where the light is spectrally and spatially filtered by the grid to form an image of the grid by the camera. Thus, a separate source and cut-off grid is not needed, resulting in a focusing schlieren system that is compact and easy to construct and align.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### BACKGROUND OF THE INVENTION

Schlieren imaging is routinely used in wind tunnel experiments as a flow visualization tool that is sensitive to density gradients. A typical conventional schlieren system collimates light from a small, point-like source using a field focusing optic (either a high-quality parabolic mirror or a lens) and passes this collimated light through a flow-field of interest. A second field focusing optic placed on the opposite side of the flow-field images the original light source at a point. A knife-edge located at this point is placed such that it blocks a portion of the image of the light source, with the remainder of the light passing through to a camera sensor. Any gradient in density that exists between the two field optics results in a refractive index gradient that diverts some of the rays of light in the light column. These diverted rays ultimately either terminate on, or pass by, the knife-edge. The resulting image captured by the camera sensor then consists of light and dark regions that correspond to structures of varying density in the flow-field.

While the qualitative images schlieren provides are useful for flow characterization, they represent the entire path-integrated density gradient field that exists between the two field focusing optics. Thus, every density gradient feature present in the field-of-view is captured in the resulting image, including features that are not pertinent to the flow of interest. Examples include non-relevant flow features, wind tunnel window scratches or chips, wind tunnel plenum or HVAC thermals, and wind tunnel wall boundary layer turbulent structures. Another drawback of the conventional schlieren visualization technique is its limited field-of-view, which is bound by the clear aperture/diameter of the field focusing optics.

The focusing schlieren technique was developed to address the limiting characteristics of the conventional schlieren system; it can significantly reduce the influence of non-pertinent flow features and can provide larger fields-of-view. Typical focusing schlieren systems use a source grid placed on one side of the density object, which is then imaged with a lens onto a matching cut-off grid on the other side of the density object. Source grids usually consist of either a one-dimensional pattern of spaced parallel line pairs or a two-dimensional regular pattern or shape. The cut-off grid must consist of a scaled duplicate of the source grid and can be challenging to create. By adjusting the offset of the cut-off grid relative to the image of the source grid, the sensitivity of the instrument to density gradients present between the source grid and imaging lens can be tuned (similar to adjusting the knife-edge insertion in a conventional system). For this type of setup, the numerous high-intensity/bright regions of the source grid effectively serve as the light sources for a number of conventional schlieren systems whose paths all intersect a common region that contains the flow feature of interest. This method of operation, in effect, defocuses the contribution of features that occur away from this common region in the final image.

The most common design is the modern large-field focusing schlieren system, which includes a light source that back-illuminates the source grid, with a Fresnel lens placed between the two in order to better direct light into the camera lens and improve brightness. The source grid is imaged onto the cut-off grid with a field lens, and the resulting focused schlieren image captured at the image plane by a camera. Placement of the source and cut-off grids relative to the field lens are readily determined using the thin lens equation, as is the placement of the schlieren object and image plane.

Another design is the retroreflective focusing schlieren system. This system includes an alternative source grid consisting of patterned retroreflective material, with illumination provided by coupling light onto the optical axis via a beam-splitting plate, and with the resulting image of the source grid incident on a matched cut-off grid. This system is useful when cross-tunnel optical access is not available, and when larger fields-of-view are required than provided by a Fresnel lens.

In another retroreflective system, the source grid is instead projected onto the screen and imaged onto a separate matched cut-off grid. Newer systems include a digital projection system used to project an image of a digital source grid onto a screen and include recent advancements in digital display technology (e.g., backlit and self-illuminating LCD and LED monitors) that enable the source grid to be tailored to the cut-off grid.

An improvement over these focusing schlieren systems involves a self-aligned focusing schlieren (FS) system that allows for the use of only a single Ronchi ruling acting as both the source and cut-off grids. While this system is a significant advancement of the art, the baseline system is only able to measure density gradients in a single direction, similar to a typical conventional schlieren system with equivalent knife-edge cut-off. Thus, the single-gradient measurement can be limiting in certain instances. For example, if we take the schlieren signal of the laminar thermal plume from a candle, when the knife-edge is oriented horizontally to measure y-direction gradients, no schlieren signal is visible. However, when the knife-edge is oriented vertically to measure x-direction gradients, the laminar thermal plume from the candle is visible. While it is easy to set the correct knife-edge orientation in this case, for more complicated flows, it is not always clear which orientation will be best to begin with. What is needed, therefore, are improved systems and methods that provide unambiguous, simultaneous, orthogonal-gradient focused schlieren images in addition to having the capability of simultaneously and colinearly making schlieren measurements and some other type of measurement (e.g., particle image velocimetry (PIV), pressure sensitive paint (PSP), temperature sensitive paint (TSP), photogrammetry, etc.).

### BRIEF SUMMARY OF THE INVENTION

Aspects of the present invention relate to schlieren methods and systems for imaging density gradients, such as in wind tunnels, while making simultaneous complementary flow/surface visualization measurements. Light may be projected through a grid (e.g., a Ronchi ruling having a shortpass and/or a longpass filter lines) and onto a background, where the light is spectrally and spatially filtered by the grid to form an image of the grid by a camera. The light from this projected image may then reflect back onto the same grid, with a polarizing refractor (e.g., a Rochon polarizing prism) imparting a small offset between the projected and reflected light, where the light is spectrally and spatially filtered by the grid to form an image of the grid by the camera. In this way, a separate source and cut-off grid is not needed, resulting in a focusing schlieren system that is compact and easy to construct and align. In various embodiments, the camera can either be a monochrome or a color camera. In various embodiments, for taking measurements using two colors, color information can be obtained by adding a color filter in front of multiple monochrome cameras.

An example embodiment of a method of schlieren imaging a density object comprises: projecting light rays with a first linear polarization along an optical axis in a projected direction; spatially and spectrally filtering the first linear polarization light rays through a grid a first time in the projected direction; passing the filtered light rays through the density object a first time in the projected direction; reflecting the filtered light rays back along the optical axis in a reflected direction opposite the projected direction; passing the reflected light rays through the density object a second time in the reflected direction; converting the reflected light rays from the first linear polarization to a second linear polarization that is offset by 90 degrees from the first linear polarization; spatially and spectrally filtering the 90-degree offset liner polarization light rays through the grid a second time in the reflected direction; and/or imaging the twice-filtered light rays, wherein when the light rays with the first linear polarization are spatially and spectrally filtered through the grid the first time, the grid functions as a source grid, wherein when the light rays with the second 90-degree offset linear polarization are spatially and spectrally filtered through the grid the second time, the grid functions as a cut-off grid, and/or wherein filtering the light rays through the same grid twice results in self-alignment without any multi-grid alignment step.

In various embodiments of the method, the spatially and spectrally filtering of the first linear polarization light rays through the grid, and the spatially and spectrally filtering of the second 90-degree offset linear polarization light rays through the grid, each include filtering the respective light rays through a Ronchi ruling grid having shortpass, longpass, bandpass, or notch filter lines.

In various embodiments, the Ronchi ruling grid is formed by imaging at least one grid pattern onto a color photographic film using at least one colored light source and developing the photographic film to result in a fabricated spectral-spatial filter comprising the Ronchi ruling grid having the shortpass, longpass, bandpass, or notch filter lines.

In various embodiments, an exemplary method further comprises simultaneously making schlieren measurements and another type of measurement using the grid, wherein the grid comprises a one-dimensional spectral-spatial filter, where, in various embodiments, the other type of measurement utilizes particle image velocimetry (PIV), pressure sensitive paint (PSP), temperature sensitive paint (TSP), or photogrammetry.

In various embodiments, the grid comprises a two-dimensional spectral-spatial filter that is simultaneously sensitive to density gradients in two orthogonal directions, where in various embodiments, an exemplary method further comprises simultaneously making schlieren measurements and another type of measurement using the grid. Additionally, in various embodiments, the other type of measurement utilizes particle image velocimetry (PIV), pressure sensitive paint (PSP), temperature sensitive paint (TSP), or photogrammetry.

In various embodiments, the imaging of the twice-filtered light rays is performed using a color camera.

In various embodiments, the imaging of the twice-filtered light rays is performed using multiple monochrome cameras with a color filter positioned in front of the monochrome cameras.

In various embodiments, the projecting of the light rays with the first linear polarization includes projecting light rays from a light source and linearly polarizing the light rays with the first linear polarization, wherein the light source projects the light rays transverse to the optical axis, and an exemplary method further comprises projecting the light rays from the light source through a beam-splitter on the optical axis that redirects the light rays onto the optical axis.

Another example embodiment of the present disclosure is related to a system for schlieren imaging a density object and comprises: a light source assembly that projects light rays having a first linear polarization; a grid that spectrally and spatially filters the light rays and is positioned on an optical axis; a background that reflects the light rays and is positioned on the optical axis; one or more optical elements that convert the light rays from the first linear polarization to a second linear polarization that is offset by 90 degrees from the first linear polarization, wherein the one or more linear polarization 90-degree offsetting optical elements are positioned on the optical axis between the grid and the background; and/or a camera system that images the light rays and is positioned on the optical axis, wherein in use the light rays are projected along the optical axis in a projected direction, spectrally and spatially filtered through the grid a first time, passed through the density object a first time, reflected off the background back along the optical axis in a reflected direction opposite the projected direction, passed through the density object a second time, spectrally and spatially filtered through the grid a second time, and incident on the camera system, and/or wherein in use the one or more linear polarization 90-degree offsetting optical elements convert the light rays from the first linear polarization to the second 90-degree offset linear polarization after the light rays are spectrally and spatially filtered through the grid the first time and before the light rays are spectrally and spatially filtered through the grid the second time so that the grid functions as a source grid (when the light rays pass through it in the projection direction) and as a cut-off grid (when the light rays pass through it in the reflection direction).

In various embodiments, the grid comprises a one-dimensional spectral-spatial filter.

In various embodiments of the system, the grid is a Ronchi ruling grid having one or more of shortpass, longpass, bandpass, or notch filter lines.

In various embodiments, the grid comprises a color photographic film material with an exposed image of the Ronchi ruling grid having one or two sets of shortpass, longpass, bandpass, or notch filter lines.

In various embodiments, the grid comprises a two-dimensional spectral-spatial filter that is simultaneously sensitive to density gradients in two orthogonal directions.

In various embodiments, the camera system comprises a color camera.

In various embodiments, the camera system comprises multiple monochrome cameras with a color filter positioned in front of the monochrome cameras.

In various embodiments, the light source projects the light rays transverse to the optical axis, and an exemplary system further comprises a beam-splitter that is positioned on the optical axis and that redirects the light rays onto the optical axis.

In various embodiments, the background is a retroreflective background.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

FIG. 1 is a flow diagram of a self-aligned focusing schlieren method according to various embodiments of the present disclosure.

FIG. 2A is a schematic diagram of a self-aligned focusing schlieren system implementing the method of FIG. 1 according to various embodiments of the present disclosure.

FIG. 2B is a schematic diagram of an exemplary one-dimensional (1D) optical spectral-spatial filter design in accordance with various embodiments of the present disclosure.

FIG. 2C is a schematic diagram of an exemplary two-dimensional (2D) optical spectral-spatial filter design in accordance with various embodiments of the present disclosure.

FIG. 3A demonstrates the operation of an exemplary 1D spectral-spatial filter having a Ronchi grid pattern (FIG. 2B) in the context of the self-aligned FS system (of FIG. 2A) in accordance with various embodiments of the present disclosure.

FIG. 3B demonstrates the operation of an exemplary 2D spectral-spatial filter having a 2D Rochi ruling grid pattern in the context of the self-aligned FS system (of FIG. 2A) in accordance with various embodiments of the present disclosure.

FIG. 4 shows the spectral response curve of a color camera in the context of the self-aligned FS system in accordance with various embodiments of the present disclosure.

FIG. 5 shows an exemplary illumination and imaging system for fabricating an exemplary spectral-spatial filter using a novel optical filter fabrication process, in accordance with various embodiments of the present disclosure.

FIG. 6 shows an exemplary 1D implementation of the novel spatial-spectral filter fabricated using the system of FIG. 5 in accordance with various embodiments of the present disclosure.

FIG. 7 shows an exemplary 2D implementation of the novel spatial-spectral filter fabricated using the system of FIG. 5 in accordance with various embodiments of the present disclosure.

FIG. 8A shows images simultaneously acquired using a self-aligned focusing schlieren image technique and an alternative imaging technique using a 1D spectral-spatial filter in accordance with various embodiments of the present disclosure.

FIG. 8B shows images simultaneously acquired using a self-aligned focusing schlieren image technique in two orthogonal directions using a 2D spectral-spatial filter in accordance with various embodiments of the present disclosure.

### DETAILED DESCRIPTION OF THE INVENTION

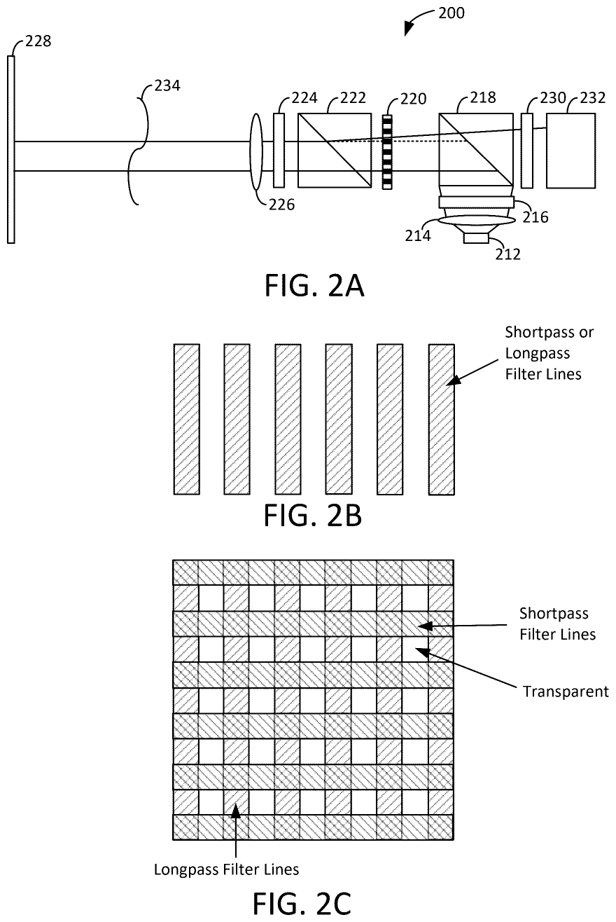

For purposes of description herein, the terms “upper,” “lower,” “right,” “left,” “rear,” “front,” “vertical,” “horizontal,” and derivatives thereof shall relate to the invention as oriented in FIG. 2A. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present disclosure presents various embodiments of a novel optical spectral-spatial filter or “grid” having a transparent substrate (e.g., a glass/plastic slide) with an optical filter coating or film grain layer (e.g., shortpass, longpass, notch, bandpass, etc.) with a certain grid design (e.g., Ronchi ruling grid lines, random speckled dot pattern, etc.). This is distinguishable from existing or conventional optical filters, (such as the filters used in, for example, U.S. Pat. No. 11,650,151), where an optical filter coating is deposited on the entire clear aperture of the optics. In various embodiments, a one-dimensional (1D) implementation of the novel optical spectral-spatial filter comprises a 1D Ronchi ruling where the opaque spatial filter lines of a typical Ronchi ruling are replaced with either bandpass, notch, shortpass, or longpass filter lines that function as spatial and spectral filters. A benefit of the disclosed 1D optical spectral-spatial filter over a traditional 1D fully opaque Ronchi grid is that by using two colors of light, measurements of focusing schlieren and another co-linear technique (particle image velocimetry (PIV), pressure sensitive paint (PSP), temperature sensitive paint (TSP), particle imaging, photogrammetry, other techniques known to one skilled in the art such as oil flow visualization, etc.) can be acquired simultaneously. In various embodiments, a two-dimensional (2D) implementation of the novel optical spectral-spatial filter comprises two orthogonal sets of Ronchi ruling lines that are created on the same transparent substrate, where one set of lines is created with a shortpass coating/layer, while the orthogonal set of lines is created with a longpass coating/layer, where each functions as spatial and spectral filters. A benefit of the disclosed 2D novel optical spectral-spatial filter over a traditional 2D fully opaque Ronchi grid is that by using two colors of light, the two orthogonal density gradients signals of the focusing schlieren system can be isolated from each other to eliminate directional ambiguity.

Thus, in various embodiments of the present disclosure, the 1D implementation of the novel optical spectral-spatial filter allows for a single-gradient focusing schlieren measurement and a simultaneous complementary flow visualization measurement (e.g., pressure sensitive paint (PSP), temperature sensitive paint (TSP), particle image velocimetry (PIV), photogrammetry, other techniques known to one skilled in the art such as oil flow visualization, etc.). In other embodiments, the 2D implementation of the novel optical spatial-spectral filter allows for simultaneous dual-gradient (orthogonal) schlieren measurements.

The two designs discussed above focus on Ronchi rulings (grid lines) created with shortpass and longpass filter coatings or film grain layers, but embodiments of the present disclosure are not necessarily limited to these two designs. For example, the types of spectral filters integrated in exemplary optical spatial-spectral filters are not limited to only shortpass and longpass coatings/layers, but can include notch, bandpass, and multiple-bandpass filter coatings/layers as well. Further, the types of spatial patterns deposited on the transparent piece of substrate material (e.g., transparent slide or film) are not limited to only grid lines (Ronchi ruling), but can include any other spatial pattern. As one example, a random dot-speckle filter pattern can be used on the slide, and simultaneous reference-free background oriented schlieren and shadowgraph measurements can be acquired.

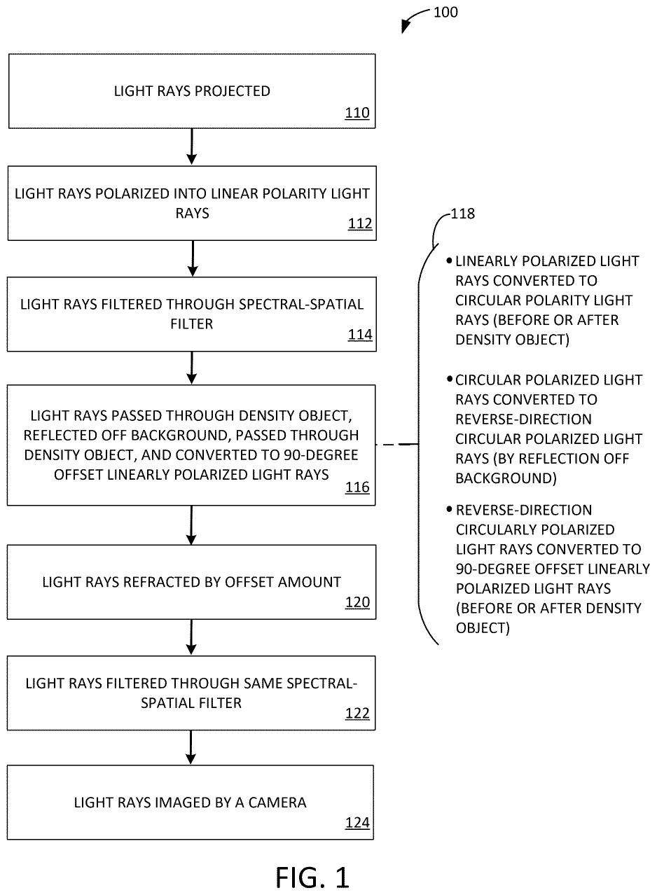

FIG. 1 shows a self-aligned focusing schlieren flowchart 100 according to a first example embodiment that utilizes an exemplary optical spectral-spatial filter to perform a self-aligned focusing schlieren method. Accordingly, the self-aligned schlieren method can be performed using self-aligned schlieren systems including those of the example embodiments described below and adapted embodiments as understood by persons of ordinary skill in the art.

The schlieren flowchart 100 includes projecting light rays at 110, for example, but not limited to, from a light source of the type commonly used in schlieren imaging, such as a laser or LED. The light source can project light that is unpolarized, randomly polarized, or polarized.

Optionally, the light can be diffused, for example using a diffusing optic such as a condenser-diffuser lens (as in embodiments described below), so that the light source itself is not imaged and so the light is spread and loosely focused/collimated to improve the brightness of the resulting schlieren image. The diffuser lens can be of a conventional type, for example with one face effectively “sanded” to provide a diffuse output of the light. Optionally, a normal optical lens, or no lens, can be used.

At block 112, the light rays are polarized into a linear polarization state, for example by a linear polarizing component. The linear polarization state can be for example vertical linear polarization (as in embodiments described below) or horizontal linear polarization. The polarizing component can be for example a linear polarizer, a polarizing beam-splitter, both a linear polarizer and a polarizing beam-splitter (as in embodiments described below), and/or other linear polarizing components. A polarizing beam-splitter can be oriented for example to reflect vertically polarized light onto the optical axis and transmit through horizontally polarized light, thereby directing only the vertically polarized light onto the optical axis for use in the schlieren flowchart 100. If unpolarized or circularly polarized light is incident on the polarizing beam-splitter, it will transmit 50 percent and reflect 50 percent. The reflected light will always be linearly vertically polarized and the transmitted light will always be linearly horizontally polarized. Because polarizing beam-splitters typically have a lower extinction ratio than linear polarizers, one or more linear polarizers can be used to increase the extinction ratio of the light. The linear polarizers can be optics (higher quality, higher cost) or film (lower quality, lower cost). Typically, a first linear polarizer is positioned between the light source and the beam-splitter for the projected light, and a second linear polarizer is positioned between the beam-splitter and an imaging device (described below) for the reflected light to further improve image contrast. In some embodiments, a non-polarizing beam-splitter is used, provided that both linear polarizers are used. The inclusion of the beam-splitter enables the schlieren flowchart 100 to be performed using a projection schlieren system with the light source transverse to the optical axis of the schlieren system implementing the schlieren flowchart 100.

In embodiments in which the light source emits light that is not linearly polarized, a linear polarizing component is included as a component of the light source or a separate component (e.g., as described herein). In such embodiments, the term “light source assembly” means the light source and an integral or separate linear polarizing component. In embodiments in which the light source produces linearly polarized light suitable for use in the schlieren flowchart 100 without enhancement, a linear polarizing component is not needed and thus need not be included. In such embodiments, the term “light source assembly” means the light source without an integral or separate linear polarizing component. Accordingly, the light projecting step 110 and the linear polarizing block 112 can be considered to form one single step in the schlieren flowchart 100.

Next at block 114, the light rays are then spectrally and spatially filtered by an exemplary optical spectral-spatial filter having a grid element, for example a 1D or 2D Ronchi ruling (as in embodiments described below), with the light rays passing through forming a grid image. The optical spectral-spatial filter is positioned along the optical axis of a schlieren system implementing the schlieren flowchart 100, with the lights rays passing through it twice (as projected and reflected lights rays, as described below).

As background, a simple Ronchi ruling is a type of spatial filter that includes a set of regular, alternating transmissive and opaque lines, where the spatial frequency is typically given in units of line-pairs per millimeter (lp/mm), which in use results in sensitivity to density (index of refraction) gradients in the direction perpendicular to the lines. This type of Ronchi ruling grid can be rotated to any other orientation to provide sensitivity in any other orientation. Note that if the Ronchi ruling grid is rotated, and if a polarizing prism (described below) is used, then the polarizing prism must also be rotated so that it always offsets the incoming lines perpendicular to the lines themselves. Another type of Ronchi ruling includes two sets of orthogonal intersecting lines forming an opaque grid defining a regular pattern of transparent squares, where the polarizing prism is rotated 45 degrees relative to the lines, so that shifting occurs in the vertical direction and in the horizontal direction, which in use results in sensitivity to density in two directions simultaneously, but the signal from the two directions cannot be distinguished from each other.

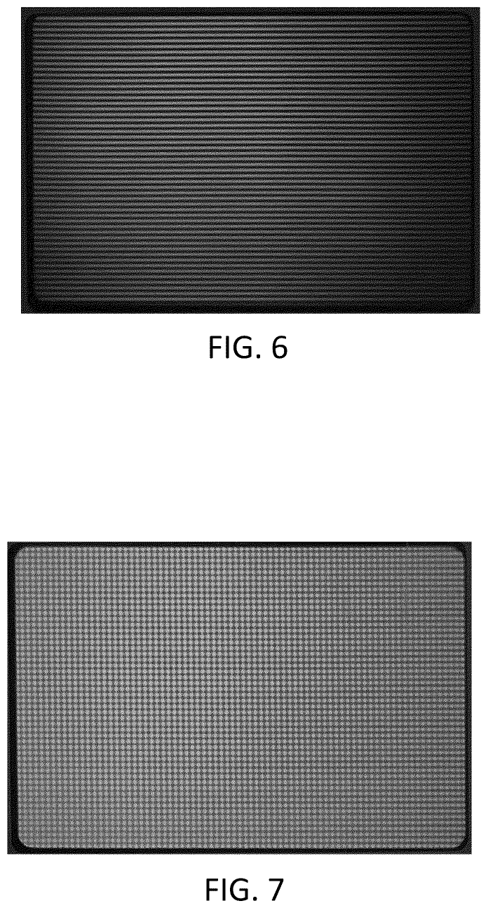

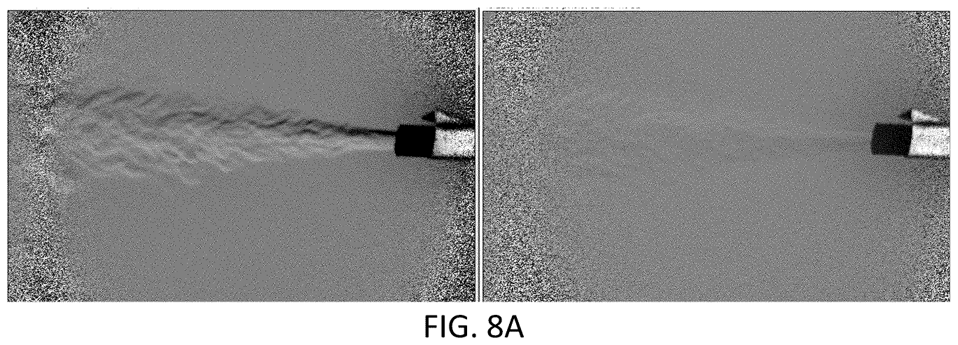

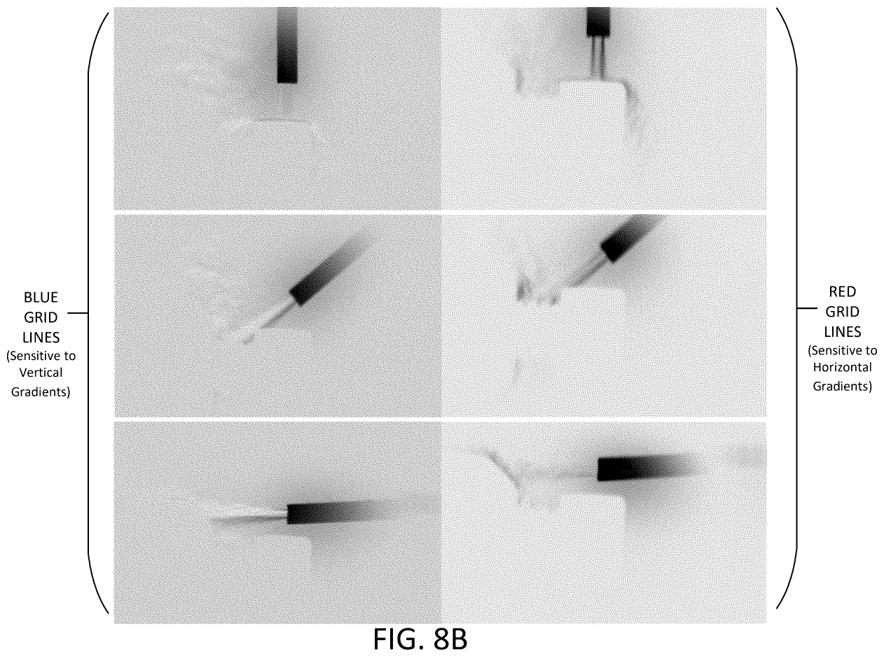

Thus, in accordance with the present disclosure, various embodiments of a novel optical spectral-spatial filter or grid are presented that are sensitive to density gradients in at least one direction and are sensitive to distinguishing or isolating different wavelengths of light. In accordance with various embodiments, a first type of the novel spectral-spatial filter comprises a one-dimensional Ronchi ruling grid pattern, where instead of the typical opaque lines, a shortpass or a longpass filter coating is deposited in the pattern of the regular grid lines. Further, in accordance with other embodiments, a two-dimensional spectral-spatial filter comprises a two-dimensional Ronchi ruling, where instead of the typical opaque grid, one set of lines in the grid is coated with a shortpass filter, and the orthogonal set of lines is coated with a longpass filter type. By using two colors of light and a color camera (or two monochrome cameras with a dichroic mirror separating the two colors) in an exemplary focusing schlieren system, either simultaneous focusing schlieren and other co-linear technique can be acquired (1D optic), as shown in FIG. 8A, or two orthogonal density gradient focusing schlieren images can be unambiguously measured (2D optic), as shown in FIG. 8B. In FIG. 8A, the left image shown in the figure is acquired using the self-aligned focusing schlieren technique and the spectral-spatial filter of FIG. 6 having horizontal Ronchi ruling grid lines for vertical gradient sensitivity (e.g., red grid lines) and the transmission of red light, where the right image is acquired utilizing full transmission of blue light that is not filtered using the Ronchi ruling grid lines. Thus, the left image shows a typical schlieren signal with good sensitivity and the right image shows very little schlieren signal even with contrast enhancement, which can be used to image fixed targets for tracking and photogrammetry measurements, or for pressure/temperature sensitive paint measurements, etc. Correspondingly, in FIG. 8B, the spectral-spatial filter of FIG. 7 having a 2D Ronchi ruling grid is used to filter the transmission of red and blue light, where blue grid lines in the Ronchi ruling grid are horizontal and red grid lines are vertical. The acquired images are on the left of the figure show the gradients captured using transmitted light filtered by the blue grid lines, where the top row is for an air jet oriented vertically, the middle row at 45 degrees, and the bottom row horizontally. Similarly, the simultaneously acquired images on the right show the gradients captured using transmitted light filtered by the red grid lines, where the top row is for an air jet oriented vertically, at the middle row at 45 degrees, and the bottom row horizontally.

Typically, for a focusing schlieren system, the light rays are focused, for example using a focusing optical lens, such as a field lens with a positive focal length. The focusing lens can be any focusing optic, such as a camera lens (a single lens or a zoom lens). The focusing lens is positioned along the optical axis of schlieren system implementing the schlieren flowchart 100, with the light rays passing through it twice (as projected and reflected lights rays, as described below).

Next at block 116, the light rays are passed through a density object, reflected off a retroreflective background, passed back through the density object, and converted (i.e., altered) to a 90-degree offset linear polarization state. By passing the light rays through the density object twice, the resulting imaging sensitivity is increased. The conversion of the linear (e.g., vertical) polarization light rays into the 90-degree offset linear (e.g., horizontal) polarization light rays can be performed at any point in this step, including at or over multiple points in this step, for example as described below, so this process is not limited to the sequence described.

The density object is anything that creates a density gradient (i.e., an index of refraction gradient) in the field or zone of interest, for example the interior space of a wind tunnel (e.g., with or without windows) or an open space. As such, a density object as used herein includes solid objects (e.g., lenses) and/or fluids in the field of interest.

The retroreflective background can be any material that reflects the incoming “projected” light back along the same path as “reflected” light. Example retroreflective backgrounds that can be used include retroreflective sheeting (e.g., 3M SCOTCHLITE 7610, commercially available from 3M Company, St. Paul, Minn.) (as in embodiments described below), retroreflective paint, a flat mirror, a concave mirror, a polished metal surface, etc.

An example of the conversion of the light rays from a linear polarization to a 90-degree offset linear polarization is detailed at block 118. First, the linear polarization light rays are converted to circular polarization light rays, then the circular polarization light rays are converted to reverse direction circular polarization light rays, and lastly, the reverse direction circular polarization light rays are converted to the 90-degree offset linear polarization light rays. For example, vertically linear polarization light rays can be converted to right circular polarization light rays, then the right circular polarization light rays are converted to left circular polarization light rays, and then the left circular polarization light rays are converted to horizontal linear polarization light rays (as in embodiments described below).

The circular polarization light rays are converted to the reverse direction circular polarization light rays by being reflected off the retroreflective background (as in embodiments described below). In particular, upon reflection off the retroreflective background, the circular polarization will change handedness (but when linear polarization is reflected, it will remain the same linear polarization). Alternatively, the circular polarization light rays can be converted to the reverse direction circular polarization light rays by another set of optics or materials, before or after being reflected off the retroreflective background.

The linear polarization light rays can be converted to circular polarization light rays, and the reverse direction circular polarization light rays can be converted to the 90-degree offset linear polarization light rays, by passing the lights rays through the same optical component twice (once in each of the projected and reflected directions). This is typically done by using a optic (higher quality, higher cost) or a film (lower quality, lower cost) that is positioned between the retroreflective background and a polarizing refractor (e.g., a polarizing prism, as described herein) (and thus between the retroreflective background and the optical spectral-spatial filter in embodiments without a polarizing refractor).

For example, this conversion to circular polarization can be done by the light rays being passed through a quarter-wave plate (QWP) optic (as in embodiments described herein) with its fast axis oriented at 45 degrees relative to the axis of the linear polarization so that it converts vertical linear polarization to right circular polarization (and vice versa) and converts horizontal linear polarization to left circular polarization (and vice versa). Optionally, if the QWP is rotated to −45 degrees (or 135 degrees, depending on where the angle is measured from), then the vertical linear will be converted to left circular and the horizontal linear to right circular. The quarter-wave plate optic retards one component of the light's polarization by one-quarter wavelength so that the output polarization is circular. The quarter-wave plate optic can be positioned between the polarizing refractor and the field lens, between the field lens and the density object, or between the density object and the retroreflective background. The quarter-wave plate optic can be positioned at a different orientation, but the resulting images produced by the schlieren flowchart 100 will be of a lower quality (because it will convert to and from elliptical polarization, instead of circular polarization).

In another example, the conversion to circular polarization is done by the light rays being passed through a QWP film that converts light rays between linear and circular polarization. The film can be positioned between the polarizing refractor and the field lens, between the field lens and the density object, or between the density object and the retroreflective background. Alternatively, the QWP film can be positioned on or integrated into the retroreflective surface of the retroreflective background, for example as a coating, other treatment, or integral material component.

In other embodiments, another optical component can be used that converts light rays between linear and circular polarization to provide the functionality described herein. As such, the schlieren flowchart 100, and schlieren systems implementing it, are not limited to only the use of linear/circular polarization conversion optical components that are QWP optics and films.

Referring back to block 116, in other embodiments, the light rays are converted directly from a linear polarization state to a 90-degree offset linear polarization state without being converted to the circular and reverse direction circular polarization states. For example, the retroreflective background can be selected with the property of effectively rotating the linear polarization of the light rays by 90 degrees upon reflection off the retroreflective background (as in embodiments described below). That is, upon reflection of the light rays, vertical linear polarization converts directly to horizontal linear polarization, and vice versa. In such embodiments, the retroreflective background functions as if a retarder is incorporated in the material of the retroreflective background, and so there is no need for a quarter-wave plate, a film, or another optic. Example non-limiting materials that can be used for the retroreflective background that provide this linear polarization 90-degree rotation include GAFFER POWER vinyl tape (commercially available from Gaffer Power, Inc., St. Petersburg, Fla.) and HILLMAN prismatic tape (commercially available from The Hillman Group, Inc., Cincinnati, Ohio).

Next at block 120, the light rays are refracted by an offset amount from the optical axis using a one-directional polarizing refractor. The polarizing refractor is positioned along the optical axis between the grid and the density object, with the light rays passing through it before and after being reflected by the retroreflective background (i.e., as projected and reflected light rays). The polarizing refractor is one-directional in that it is refracting in only one direction and only for one linear polarization state, that is, in a first direction one type of linear polarized light (e.g., vertical or horizontal) is transmitted through without refraction, and in a second opposite colinear direction that linear polarized light is transmitted through but refracted. In schlieren systems implementing the schlieren flowchart 100, the polarizing refractor is oriented so that the projected light rays (linear polarization) are transmitted along the optical axis, without refraction, and the reflected light rays (90-degree offset linear polarization) are transmitted through, but refracted by a relatively small offset relative to the optical axis (e.g., due to the different refractive index encountered by the orthogonal linear polarization states). For example, the “small” offset is typically a distance equal to, or less than, the line spacing on the grid.

In some embodiments, the polarizing refractor is a polarizing prism, for example a Rochon prism (as in embodiments described herein), including a regular Rochon prism or a modified Rochon prism. The Rochon prism is oriented so that the reverse direction linear (e.g., horizontal) polarization light rays are transmitted through but refracted by a small offset angle relative to the optical axis.

It will be noted that, when a polarizing beam-splitter is used in the schlieren flowchart 100 (as optionally described above), the polarizing beam-splitter is selected and oriented (in schlieren systems implementing the flowchart 100) so that it reflects the linearly polarized light rays onto the optical axis, but not the reverse direction linearly polarized light rays. Thus, the projected light rays that the polarizing refractor “sees” are only linear (e.g., vertical) polarization state (which pass through, without being refracted) and the reflected light rays that the polarizing refractor “sees” are only 90-degree offset linear (e.g., horizontal) polarization state (which pass through, but are refracted).

Furthermore, the polarizing refraction at block 120 is typically, but not necessarily, included in the schlieren flowchart 100 (and schlieren systems implementing the flowchart 100) for good sensitivity and resulting imaging (e.g., for 50-percent cut-off imaging). As such, after the light rays pass through the spectral-spatial filter (see, e.g. block 114), but before block 116 of the flowchart 100, the light rays pass through the polarizing refractor along the optical axis, without refraction. In some embodiments, the polarizing refraction 120 is not included in the schlieren flowchart 100 (or schlieren systems implementing the flowchart 100), with the results providing less sensitivity and no information between positive and negative gradients, but still being useful for visualizing density objects.

The light rays may be filtered by the same spectral-spatial filter as in block 114 (Sec, e.g., block 122). Whereas the projected light rays were linear (e.g., vertical) polarization light rays filtered through the spectral-spatial filter in the projection direction, the reflected light rays were 90-degree offset linear (e.g., horizontal) polarization light rays filtered through the spectral-spatial filter in the opposite reflection direction. Thus, the filter image formed by the lights rays is incident to the spectral-spatial filter element with a small offset, providing partial cut-off of the filter image and thus increased sensitivity to the density object.

Because the same spectral-spatial filter is used as the source spectral-spatial filter (when the light rays pass through it in the projection direction) and as the cut-off spectral-spatial filter (when the light rays pass through it in the reflection direction), there is no need to set up and align multiple spectral-spatial filters in order to accomplish the resulting schlieren imaging in this example set up of schlieren flowchart 100. In this way, the schlieren flowchart 100 (and schlieren systems implementing the schlieren flowchart 100) are self-aligning and compact relative to other schlieren systems and flowcharts.

The light rays are then imaged by a camera or other imaging sensor device (such as at block 124). In accordance with various embodiments of the present disclosure, a color camera is used, such as, but not limited to, a BASLER acA1920-40gc camera having a global shutter with a color sensitive sensor. Global shutters allow for an entire image to be acquired at a single instant in time to avoid ambiguity and smearing of signals. In certain embodiments, the color camera is positioned along the optical axis at the image focal plane.

Having described details of example embodiments of the example schlieren flowchart 100, details of example embodiments of schlieren systems that can be used to implement the schlieren flowchart 100 will now be described with respect to FIG. 2A. As such, details of the schlieren flowchart 100 described above apply to and can be included in the schlieren systems described below, and details of the schlieren system described below apply to and can be included in the schlieren method described above.

FIG. 2A is a schematic diagram of a self-aligned focusing schlieren system 200 according to various embodiments of the present disclosure and implementing the schlieren flowchart 100 of FIG. 1. The schlieren system 200 is shown as including a light source 212, a condenser-diffuser (CD) lens 214, a first linear polarizer (LP) 216, a polarizing beam-splitter (PBS) 218, a spectral-spatial filter 220 having a grid pattern, a polarizing refractor 222, a quarter-wave plate (QWP) 224, a field lens 226, a retroreflective background (RBG) 228, a second linear polarizer (LP) 230, and a camera 232 for generating schlieren images of a density object 234. The polarizing beam-splitter 218, the spectral-spatial filter 220, the polarizing refractor 222, the quarter-wave plate 224, the field lens 226, the retroreflective background 228, the second linear polarizer 230, and the camera 232 are all positioned in that arrangement and aligned along and define an optical axis, with the light source 212, the condenser-diffuser lens 214, and the first linear polarizer 216 orthogonal to the optical axis.

Details of these components of the schlieren system 200 are described above, with additional details and possible alternatives described below. In addition, to demonstrate variations and versatility of the schlieren system 200, the below description includes details on two test configurations: one for imaging small-scale fields-of-view and another for imaging large-scale fields-of-view. For these described variations, the system 200 may have lower transmitted light intensity but is still functional for its intended purposes.

In various embodiments, three light sources 212 are used for the images displayed in the drawings. These three light sources 212 are merely examples. The first is a white LED operating continuously, the second is a red LED operating continuously, and the third is a 640 nm Cavilux laser, operating in pulsed mode. In one configuration, the system 200 was more efficient when the polarization state of the incoming light matches the reflected polarization of the polarizing beam-splitter (PBS) 218. Therefore, one good configuration for the system, among others, utilizes a linearly polarized light source 212, where the light has the same polarization state as that reflected by the PBS 218 and coupled into the instrument/system 200, such that 100% of the light is reflected onto the optical axis and used for illumination. For unpolarized/randomly polarized light, only a fraction of the initial intensity of the light is coupled onto the optical axis and used for illumination, such that the remainder of the light passes through the PBS 218 and out of the system 200.

In various embodiments, for an exemplary system 200, any light source 212 (unpolarized, randomly polarized, elliptically/circularly/linearly polarized) can be used. The amount of light reflected onto the optical axis of the system 200 will differ for each of these light sources, but the focusing schlieren system 200 operates in the same way for all. Monochromatic light sources are well-suited if chromatic aberrations become more pronounced. Generally, this is more prevalent for larger-scale systems, whereas for the smaller-scale systems, broadband white light typically works sufficiently well. Additionally, a light source 212 may be selected that falls within the limits of any anti-reflection coating used on the optics of the system 200 and within the spectral sensitivity of the camera being used.

The CD 214 is not restricted to a condenser lens, and any type of focusing lens may be used to accomplish the same task. Additionally, the use of a diffuser is not strictly necessary but is helpful if one desires to better diffuse the light from the light source 212.

In accordance with the present disclosure, a color camera 232 may be used, such as, but not limited to, a BASLER acA1920-40gc camera having a global shutter with a color sensitive sensor. Global shutters allow for an entire image to be acquired at a single instant in time to avoid ambiguity and smearing of signals. In certain embodiments, the camera is positioned along the optical axis at the image focal plane.

The polarizing refractor 222 in this embodiment may be a polarizing prism (PP), specifically, a quartz Rochon prism (RP). The Rochon prism includes two right angle prisms made from quartz which are then cemented together such that their optical axes are orthogonal to one another. The ordinary ray (o-ray) passes straight through the prism, while the extraordinary ray (e-ray) is refracted, and leaves the exit face of the prism at an angle dictated by the thickness, material, and structure angle of the prism.

In addition to quartz Rochon prisms, magnesium-fluoride (MgF₂), calcite, or α-BBO are also typically used as materials. Such alternative prisms can be used in this system 200 as well, but during the design process, it should be noted that for an equivalently sized prism, the deviation angle will be different than that of a quartz Rochon prism. As would be appreciated by those skilled in the art with the benefit of this disclosure, this angle should be chosen based on individual constraints for the system 200 including, but not limited to, the frequency (line pairs per millimeter) of a Ronchi ruling or other filtering grid utilized by the spectral-spatial filter 220.

Because polarized light travels in both directions through the polarizing prism 222 along the optical axis (on the projected path and the reflected path), the properties of how the light interacts with the prism in both directions must be known or evaluated. The light behaves differently in the forward (correct) direction versus the reverse direction for the quartz Rochon prism used in testing the system 200. A modified Rochon prism, in which having a non-birefringent piece of index-matched glass is used as the entry-half of the conventional Rochon prism, instead of using quartz (or other typical prism material) for that half of the prism should operate the same in the reverse direction as it does in the forward/correct direction.

Another polarizing prism that can be used in place of the Rochon prism is the Sénarmont prism. The entry half of the prism has the same optical axis orientation as the entry half of the Rochon prism, but the exit half of the Sénarmont prism has the optical axis rotated 90 degrees from that of the Rochon. A modified version of this prism can also be constructed in the same manner as the modified Rochon prism.

A benefit of the Rochon and Sénarmont prisms is that one of the rays passes straight through the prism while the other ray (of orthogonal polarization) leaves the exit face at a slight angle relative to the optical axis of the system. This means that the prism can be moved relative to the Ronchi ruling or other appropriate grid element of the spectral-spatial filter 220 to provide different levels of sensitivity (as described herein). That is, the offset of the reflected filter imaged onto the spectral-spatial filter 220 can be adjusted, similar to how the knife-edge insertion can be adjusted in a conventional schlieren system.

A conventional parallel beam displacer has a fixed beam displacement distance. This works well when paired with a single matched spectral-spatial filter grid. When adjustment of the sensitivity of the system is desired, an adjustable parallel beam displacer can be used. With a variable calcite beam displacer, the angle and offset between the two calcite prisms determines the offset of the two orthogonally polarized beams. Note that such a prism is not necessarily limited to the use of calcite.

It should also be noted that the system 200 can work without a polarizing prism 222. Because there is no offset induced in the reflected spectral-spatial filter onto the cut-off spectral-spatial filter 220, the system 200 without the polarizing prism 212 can act as a bright-field schlieren system. Because the grid pattern of the filter 220 reflects directly back onto themselves, any shift due to a density object, either positive or negative, will cause the image brightness to decrease. This system 200 without the polarizing prism 212 is less sensitive and does not give information between positive or negative gradients, but can still be used to visualize density objects.

Two linear polarizers are depicted in the system 200. Variations of the focusing schlieren system 200 can include both, one, or none of these linear polarizers, with at least the reasoning outlined in this section (amongst others). As mentioned above, any light source can be used, including unpolarized/randomly polarized, linearly polarized, or anything in between. When using the PBS 218 to direct the light onto the optical axis, the outgoing light from the light source 212 will be vertically polarized (with the PBS 218 in its default orientation, although this can also be rotated such that horizontal polarized light is reflected and vertical polarized light is passed straight through). If an unpolarized/randomly polarized light source is being used, the reflected intensity will be a fraction of the light source's intensity. If the light source 212 is vertically polarized, then the PBS 218 will reflect 100% of the intensity, with no light passing through. This is a well performing setup for the system 200, as no light is wasted. If, in this case, a vertically polarized light source 212 is being used, the linear polarizer 216 is not strictly necessary, as the polarization state is already aligned with that of the PBS 218. As mentioned before, the PBS 218 will take any other polarization state of light and only reflect the vertical polarization. However, the extinction ratio of a PBS 218 is typically less than that of a linear polarizer 216, and so using a linear polarizer before the PBS can improve the quality of the vertically-polarized outgoing beam. By improving the linearity of the polarization, a sharper image of the grid pattern of the spectral-spatial filter 220 (e.g., Ronchi ruling grid) will be projected on the retroreflective background 228. While the LP may not be necessary when the light source polarization matches the PBS reflection polarization, it may be useful as a means to control the intensity of light coupled into the instrument/system 200 onto the optical axis. Instead of adjusting the exposure time of the camera 232, for example, the LP 216 can instead be rotated to decrease the transmitted intensity of the light.

The linear polarizer 230 in front of the camera 232 is also optional, but can be used to improve contrast of the resulting images. This is again partially due to the high extinction ratio of linear polarizers over that of the PBS 218.

The quarter-wave plate that is included in the example system 200 converts the outgoing/projected linear polarization to circular polarization, and converts the incoming/reflected circular polarization back to linear polarization. This optic is not strictly needed when using some versions of a quartz Rochon prism 222 with larger refraction angles, but may be needed, for instance, when using the modified Rochon prism with the example system 200. Another alternative to the QWP optic 224 is the use of a Faraday rotator.

An alternative to using the QWP optic in the example system 200 is to use QWP film (which is also generally less expensive, and available with larger clear apertures). The QWP optic can then be removed from the system 200, and the QWP film placed either in the same position as the QWP optic or directly over the RBG material. When placed directly over the RBG material, linear (e.g., vertical) polarization light passes through the density object, is converted to circular (e.g., right) light by the QWP film, is reflected by the RBG and converted to circular (e.g., left) light, is converted to linear (e.g., horizontal) polarization light by the QWP film, passes through the density object 234, and proceeds as normal through the rest of the system 200. A potential design consideration of this approach is that the quality of QWP film is generally lower than an equivalent QWP optic. Another potential design consideration is that the QWP film adds thickness to the RBG 228, which could be problematic if the RBG is fixed to the inside of a wind tunnel test section, where the flow would then be affected more than if the RBG were by itself and the QWP positioned elsewhere.

In various embodiments, the system 200 includes a Ronchi ruling (RR) for the grid pattern of the spectral-spatial filter 220 created with shortpass and longpass filter coatings/layers. However, the types of spectral filters integrated in the spectral-spatial filter are not limited to only shortpass and longpass coatings, but can include notch, bandpass, and multiple-bandpass filter coatings/layers as well. Further, the types of spatial patterns integrated in the spectral-spatial filter 220 are not limited to only grid lines (Ronchi ruling), but can include any other spatial pattern. As one example, a random dot-speckle filter pattern can be used in various embodiments. Accordingly, custom grids/rulings 220 can be formed (e.g., drawn or printed onto a slide or file (e.g., glass) and the system 200 will work well, because the system 200 is self-aligned (the projected ruling is imaged directly back onto itself when the polarizing prism is removed from the system). As such, any type of grid (ruling) can be used since the system 200 is inherently self-aligned, including prefabricated or custom film, glass, etc.

In accordance with various embodiments, one type of the spectral-spatial filter 220 used in the present disclosure is a 1D filtering grid comprised of a transparent slide onto which regularly spaced shortpass or longpass filter lines are deposited/printed that function as spectral and spatial filters. In other embodiments, another type of the spectral-spatial filter 220 is a 2D filtering grid comprised of a transparent slide onto which two orthogonal sets of regularly spaced filter lines are deposited/printed, with one set of lines acting as a shortpass filter and the other set of orthogonal lines acting as a longpass filter. In various embodiments, by using a color camera 232 in an exemplary self-aligned FS system, short wavelength (e.g., blue) and long wavelength (e.g., red) channels can be viewed separately.

Next, a schematic of an exemplary 1D optical spectral-spatial filter design is shown in FIG. 2B. It is a one-dimensional Ronchi shortpass or longpass filter, where shortpass or longpass filter lines are deposited on a transparent substrate (e.g., a glass slide). A simplified and illustrative example of a 1D spectral-spatial filter may have shortpass lines (e.g., cut-off wavelength of 500 nm), where the shortpass filter passes blue light and blocks green through red light. Accordingly, if blue light is projected through this type of 1D spectral-spatial filter, the projected light would not be blocked/filtered and would appear fully uniform because both the transparent lines and the shortpass lines transmit the light. However, if green through red light is projected through the optical filter, an image of a typical Ronchi ruling would be seen, since the light passes through the transparent lines but is blocked by the shortpass lines. On the other hand, if the 1D spectral-spatial filter is made with longpass filter lines instead (e.g., cut-on wavelength of 600 nm), red light would appear uniform, and green through blue light would project an image of the grid. It is noted that notch and bandpass filters could also be used if desired.

There are many methods that can be used to produce optical filter coatings. These methods include evaporative, ion-assisted electron-beam evaporative deposition (E-Beam IAD), advanced plasma deposition (APS), plasma assisted reactive magnetron sputtering (PARMS), ion beam sputtering (IBS), and atomic layer deposition (ALD), to name a few. Additionally, various embodiments of the present disclosure include a novel optical filter fabrication process using color film (as discussed with respect to FIG. 5) with the filter lines being included as part of the grain layer of the film.

A schematic of an exemplary 2D shortpass/longpass Ronchi ruling design is shown in FIG. 2C. The design features two Ronchi rulings with their axes orthogonal to each other (e.g., red and blue). The shortpass filter lines (e.g., blue lines) allow shorter wavelengths to pass but block longer wavelengths, defined by its cut-off wavelength (e.g., 500 nm). These lines provide the equivalent of the horizontal knife-edge in a conventional schlieren system, resulting in sensitivity to vertical density gradients. The longpass filter lines (e.g., red lines) allow longer wavelengths to pass but block shorter wavelengths, defined by the cut-on wavelength (e.g., 600 nm). These lines provide the equivalent of the vertical knife-edge in a conventional schlieren system, resulting in sensitivity to horizontal density gradients.

In the example system 200, a polarizing beam-splitting cube is used. A beam-splitting plate can also be used instead of the cube, but ghosting from the back surface of the plate may be more noticeable. A non-polarizing beam-splitter can also be used, but the transmitted intensity through the system may be diminished. To avoid projection of a double image of the grid element on the RBG 228, the first linear polarizer 216 is included in the system 200. To isolate the correct reflected (incoming) beam that has been cut off by the spectral-spatial filter 220, the second linear polarizer 230 is included in the system 200.

If using a PBS 218, the orientation of the reflected linear polarization is of no consequence. That is, it can be oriented such that either vertical polarized light or horizontal polarized light is reflected onto the optical axis, as an example. The field lens 226 can be chosen based on the size of the field-of-view/test section and the position of the density object 234 of interest. It should be noted that lenses of any focal length can be used, depending on the application. The lens can be a typical camera lens (NIKON, CANON, etc.) or a scientific lens (achromats, aspherics, etc.). It should also be noted that it may be necessary to use a relay lens before the camera 232 in order to achieve a desired magnification of the density object 234 on the camera sensor.

In various embodiments, other variations of the self-aligned focusing schlieren system can be used having different arrangements of the optical elements, such as the position of the quarter-wave plate (QWP) 224 and the field lens (FL) 226 being switched, as a non-limiting example. Accordingly, the polarizing prism can be positioned anywhere between the spectral-spatial filter 220 and the density object (including between the FL and the density object, as described above) as long as the QWP is placed between the PP and RBG. A benefit of placing the QWP after the FL is that it reduces the reflections/glare from the FL optics. Modifications to the schlieren system 200 can be made as described for the other embodiments disclosed herein.

Correspondingly, in certain embodiments, the quarter-wave plate (QWP) 224 may be repositioned to be immediately adjacent (e.g., slightly spaced from, contacting, or integrated into) the incident reflecting surface of the RBG 228. As such, the polarizing prism can be positioned anywhere between the spectral-spatial filter 220 and the density object (including between the FL and the density object, as described above) as long as the QWP is placed between the PP and RBG. A benefit of placing the QWP immediately in front of the RBG is that it reduces the window reflections/glare (if windows are included in the system). Modifications to the schlieren system 200 can be made as described for the other embodiments disclosed herein.

Two configurations of the system 200 described above were constructed for testing the effectiveness of aspects of the schlieren flowchart 100. For this purpose, the preliminary/initial placement of the optics (e.g., the RBG 228, the spectral-spatial filter 220, and the camera sensor 232 relative to the field lens (FL) 226 can be determined by application of the thin lens equation:

$$\frac{1}{f} = \frac{1}{{d}_{o}} + \frac{1}{{d}_{i}}$$

where f is the focal length of the lens 226, do is the either the distance from the spectral-spatial filter 220 to the lens 226 or the distance from the lens 226 to the density object 234, and di is either the distance from the lens 226 to the retroreflective background 228 or the distance from the lens 226 to the image of the density object. This and/or other methodologies may be used for preliminary placement only, for example because as optics are added to the system 200, these calculated distances may change, since the values are derived assuming only a thin lens/optic is present. When designing the system 200 for a wind tunnel, for instance, the background pattern 228 will often be placed on the opposite wall of the tunnel, and the model/density object 234 will usually be placed at the center of the wind tunnel. The grid pattern of the spectral-spatial filter 220 needs to be projected to the background 228, and the model 234 needs to be imaged on the camera 232, so the size of the wind tunnel would dictate these distances. Two separate applications of the thin lens equation may be applied: one for the position of the spectral-spatial filter 220 to project to the background 228, and one for the model/density object 234 imaged to the camera 232.

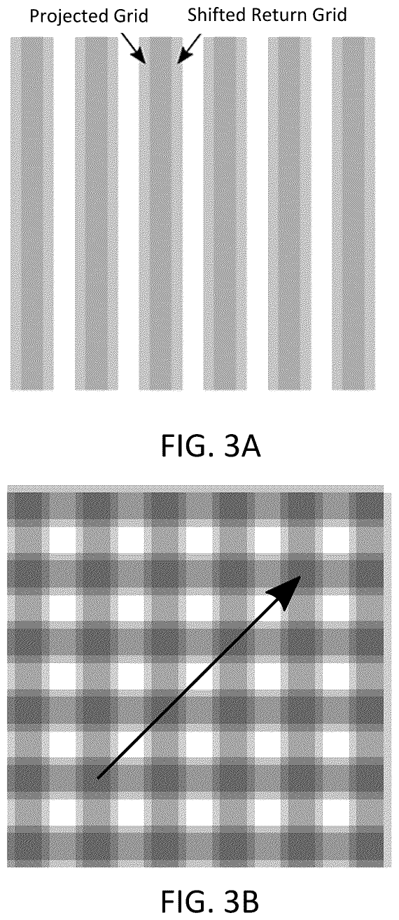

The operation of an exemplary one-dimensional spectral-spatial filter having a Ronchi grid pattern (FIG. 2B) in the context of the self-aligned FS system (of FIG. 2A) can be seen in FIG. 3A. In this example, it is assumed that the filter lines are of the shortpass type. Thus, if red light is projected through the optic, the Ronchi grid pattern will be projected, reflected off of the retroreflective background material (RBG), and then be shifted slightly relative to the grid due to the influence of the polarizing prism (PP), as shown in the figure. This slight shift provides the cut-off equivalent to the knife-edge in a conventional schlieren system.

In accordance with the present disclosure, if blue light is simultaneously projected through the self-aligned FS system, it will be uniformly projected, uniformly reflected, and will also be uniformly transmitted back through the system and into the camera 232. Accordingly, the red-channel of the camera 232 will display the typical focusing schlieren image, while the blue-channel light can be used for other simultaneous, co-linear techniques (PIV, PSP, TSP, particle imaging, oil flow visualization, etc.).

Referring now to FIG. 3B, this figure demonstrates the operation of an exemplary two-dimensional spectral-spatial filter having a 2D Rochi ruling grid pattern (with horizontal blue lines and vertical red lines) in the context of the self-aligned FS system (FIG. 2A). Here, both red light and blue light are projected through the system from the light source. After the projected grid has been reflected at the RBG, the incoming grid is shifted relative to the 2D optic itself by the polarizing prism as indicated by the arrow in the figure. It is noted that a single polarizing prism can be used if it is oriented 45 degrees relative to the shortpass and longpass lines. This schematic shows both the original grid and the slightly shifted incoming grid. The horizontal blue grid lines have been shifted up, while the vertical red grid lines have been shifted right. Note that the blue lines have also been shifted right, and the red lines up, but those shifts are not visible due to the orientation of each set of lines (the shifts are parallel to the lines). The blue light will project vertical grid lines, and thus isolating the blue-channel of the camera will result in self-aligned FS images that are sensitive to horizontal gradients. The red light will project horizontal grid lines, and thus isolating the red-channel of the camera will result in self-aligned FS images that are sensitive to vertical gradients.

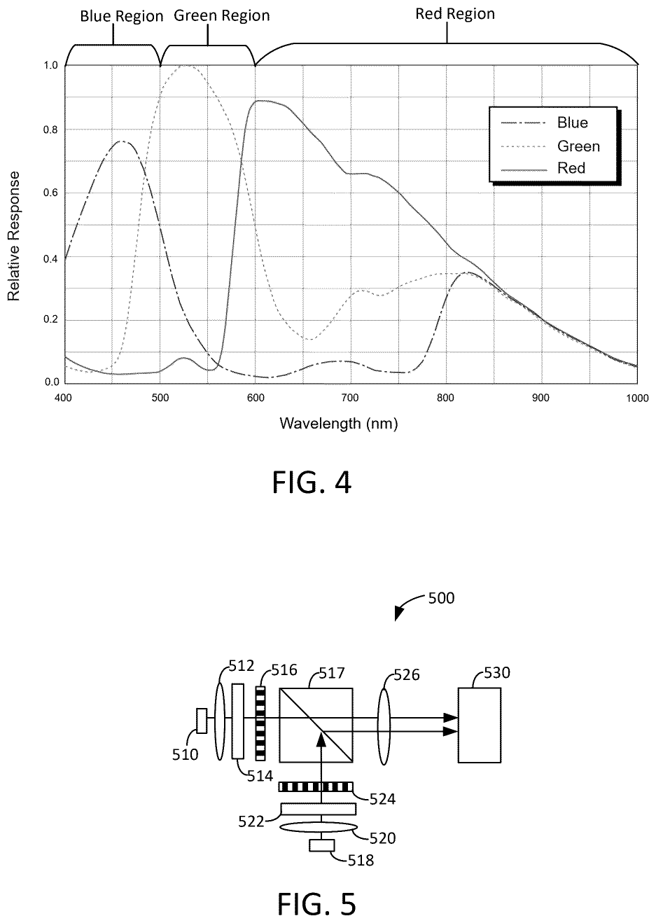

The spectral response curve of the camera 232 (specifically, BASLER acA1920-40gc color camera) can be seen in FIG. 4 (which is provided from the camera's manufacturer's website). When the 2D shortpass/longpass filter coating is used, shorter wavelengths (e.g., blue) project a vertical grid which is sensitive to horizontal gradients, and longer wavelengths (e.g., red) project a horizontal grid which is sensitive to vertical gradients. Upon retroreflection, both the blue light and red light will be transmitted back through the system and into the camera 232. Thus, the spectral response curves for blue, green, and red channels (lines) indicate that the two orthogonal grid signals (shaded regions) can be separated from one another. When the cut-off wavelength for the shortpass filter lines is 500 nm, the blue shaded region in the plot indicates the wavelength range of the transmitted light, and the blue curve shows that the camera's blue channel will isolate this signal from any red light. Similarly, when the cut-on wavelength for the longpass filter lines is 600 nm, the red shaded region indicates the wavelength range of the transmitted light, and the red curve shows that the camera's red channel will isolate the signal from any blue light. Thus, by viewing either signal from the camera's blue or red channel, the horizontal or vertical gradient signals, respectively, can be independently viewed. It is noted that the blue channel has an increased response past 775 nm. Therefore, to achieve completely isolated red-channel images, the filter lines should in fact be of the bandpass type, with a cut-on near 600 nm and a cut-off before 750 nm.

While the two designs discussed above focus on Ronchi rulings (grid lines) created with shortpass and longpass filter coatings/layers, embodiments of the present disclosure are not necessarily limited to these two designs. For example, the types of spectral filters integrated in exemplary spectral-spatial filters 220 are not limited to only shortpass and longpass coatings/layers, but can include notch, bandpass, and multiple-bandpass filter coatings/layers as well. Further, the types of spatial patterns deposited on the transparent piece of substrate material (e.g., transparent slide or film) are not limited to only grid lines (Ronchi ruling), but can include any other spatial pattern. As one example, a random dot-speckle filter pattern can be used on the slide, and simultaneous reference-free background oriented schlieren and shadowgraph measurements can be acquired. Also, in various embodiments, instead of a single color camera, a dichroic beamsplitter can be used to split the view between two monochrome cameras with appropriate full-aperture color filters matching the Ronchi grid filter wavelength bounds.

One of the unique/novel features of the disclosed designs include the creation of regular patterns of alternating clear substrate and filter lines, in either a 1D pattern or a 2D orthogonal pattern. Thus, when using the 1D optic, simultaneous and co-linear measurements of focusing schlieren and another optical technique (PIV, PSP, TSP, particle imaging, photogrammetry, oil flow visualization, etc.) can be made, as shown in FIG. 8A. And, when using the 2D optic, simultaneous and unambiguous focusing schlieren measurements of two orthogonal density gradients can be made, as shown in FIG. 8B. To the best of the inventors' knowledge, current optical filters are only fabricated and sold with the filters covering the full clear-aperture of the substrate on which the filter is deposited.

As mentioned, various embodiments of the present disclosure include a novel optical filter fabrication process using color photographic film as the filter medium. While optical filters can be fabricated using a variety of techniques, such as Ion-assisted electron-beam evaporative deposition (E-Beam IAD), advanced plasma deposition (APS), atomic layer deposition (ALD), etc., these processes generally require a high financial cost to implement or deploy. Thus, a low-cost alternative process has been developed to fabricate spectral-spatial filters, in accordance with the present disclosure, using color photographic film (e.g., KODAK EKTACHROME E100). Consider in the case of the KODAK EKTACHROME E100 film, modulation transfer function (MTF) curves show that high-quality Ronchi rulings can be used at typical operating lp/mm values for self-aligned focusing schlieren (approximately 1 to 20 lp/mm). Additionally, due to the spatial frequency resolution of the film, it can be used for higher lp/mm values (e.g., up to approximately 80 lp/mm). Additionally, for a roll of E100 film having 36 exposures, 36 unique patterns can be produced using one roll which results in considerable cost savings over alternative fabrication processes. Thus, via an exemplary novel optical filter fabrication process of the present disclosure, manufacturing time can be significantly reduced, and the cost-per-optic decreased by many orders of magnitude

FIG. 5 shows an exemplary illumination and imaging system 500 for fabricating an exemplary spectral-spatial filter using the novel optical filter fabrication process, in accordance with various embodiments of the present disclosure. The system 500 is shown as including a first LED light source (e.g., blue LED) 510, a first condenser-diffuser (CD) lens 512, a first linear polarizer (LP) lens 514, a first grid pattern (e.g., Ronchi ruling grid) 516, a polarizing beam-splitter (PBS) 517, a second LED light source (e.g., red LED) 518, a second condenser-diffuser (CD) lens 520, a second linear polarizer (LP) lens 522, a second grid pattern (e.g., Ronchi ruling grid) 524, a field lens 526, and a color film camera 530. The first LED light source (e.g., blue LED) 510, first condenser-diffuser (CD) lens 512, first linear polarizer (LP) lens 514, first grid pattern (e.g., Ronchi ruling grid) 516, the polarizing beam-splitter (PBS) 517, the field lens 526, and color film camera 530 are all aligned along and define an optical axis, with the second LED light source (e.g., red LED) 518, second condenser-diffuser (CD) lens 520, second linear polarizer (LP) lens 522, and second grid pattern 524 orthogonal to the optical axis.

In use, the field lens 526 forms an image of two back-illuminated (e.g., red or blue) grid patterns 516, 524 onto the photographic film of the color camera 530 (e.g., NIKKON NIKOMAT EL), where the developed photographic film results in a fabricated spectral-spatial filter or grid 220. Exposure of the photographic image is controlled via the respective LED pulse width, with the camera shutter opened over the entire exposure duration. Within the system 500, the grid patterns 516, 524 can be inserted or removed, can be placed in any rotational orientation, and can have different grid spacings/densities, based on design preferences.

Thus, to make the 2D implementation of the novel optical spectral-spatial filter 220 with two orthogonal sets of Ronchi ruling lines, the system 500 of FIG. 5 can be used with two grid patterns (Ronchi ruling grids) 516, 524 being positioned to form the requisite 2D pattern. Alternatively, to make the 1D implementation of the spectral-spatial filter 220 with one set of Ronchi ruling lines, then only one of the grid patterns (Ronchi ruling grid) 516, 524 is used to form the requisite 1D pattern. Correspondingly, if different colors of lines are desired, then different color LEDs can be used as the first and second LED light sources 510, 518 (e.g., in place of blue and/or red LEDs).

Accordingly, for illustration purposes, FIG. 6 shows an exemplary 1D implementation of the novel spatial-spectral filter fabricated using the system of FIG. 5. Here, only one Ronchi ruling grid was used in the system to form the film-version of the spectral-spatial filter having horizontal colored lines only. Correspondingly, FIG. 7 shows an exemplary 2D implementation of the novel optical spectral-spatial filter fabricated using the system of FIG. 5, where two Ronchi ruling grids were used in the system to form the film-version of the novel optical spectral-spatial filter having red horizontal lines and blue vertical lines.

It should be emphasized that the above-described embodiments are merely possible examples of implementations, merely set forth for a clear understanding of the principles of the invention. Many variations and modifications may be made to the above-described embodiments without departing substantially from the principles of the invention. All such modifications and variations are intended to be included herein within the scope of this disclosure.

What is claimed is:

1. A method of schlieren imaging a density object, comprising:
projecting light rays having a first linear polarization along an optical axis in a projected direction;
spatially and spectrally filtering the first linear polarization light rays through a grid a first time in the projected direction;
passing the filtered light rays through the density object a first time in the projected direction;
reflecting the filtered light rays back along the optical axis in a reflected direction opposite the projected direction;
passing the reflected light rays through the density object a second time in the reflected direction;
converting the reflected light rays from the first linear polarization to a second linear polarization that is offset by 90 degrees from the first linear polarization;
spatially and spectrally filtering the 90-degree offset liner polarization light rays through the grid a second time in the reflected direction; and
imaging the twice-filtered light rays,
wherein when the light rays with the first linear polarization are spatially and spectrally filtered through the grid the first time, the grid functions as a source grid, wherein when the light rays with the second 90-degree offset linear polarization are spatially and spectrally filtered through the grid the second time, the grid functions as a cut-off grid, and wherein filtering the light rays through the same grid twice results in self-alignment without any multi-grid alignment step.

2. The schlieren imaging method of claim 1, wherein spatially and spectrally filtering the first linear polarization light rays through the grid, and spatially and spectrally filtering the second 90-degree offset linear polarization light rays through the grid, each include filtering the respective light rays through a Ronchi ruling grid having shortpass, longpass, bandpass, or notch filter lines.

3. The schlieren imaging method of claim 2, wherein the Ronchi ruling grid is formed by imaging at least one grid pattern onto a color photographic film using at least one colored light source and developing the photographic film to result in a fabricated spectral-spatial filter comprising the Ronchi ruling grid having the shortpass, longpass, bandpass, or notch filter lines.

4. The schlieren imaging method of claim 1, further comprising simultaneously making schlieren measurements and another type of measurement using the grid, wherein the grid comprises a one-dimensional spectral-spatial filter.

5. The schlieren imaging method of claim 4, wherein the other type of measurement utilizes particle image velocimetry (PIV), pressure sensitive paint (PSP), temperature sensitive paint (TSP), or photogrammetry.

6. The schlieren imaging method of claim 1, wherein the grid comprises a two-dimensional spectral-spatial filter that is simultaneously sensitive to density gradients in two orthogonal directions.

7. The schlieren imaging method of claim 6, further comprising simultaneously making schlieren measurements and another type of measurement using the grid.

8. The schlieren imaging method of claim 7, wherein the other type of measurement utilizes particle image velocimetry (PIV), pressure sensitive paint (PSP), temperature sensitive paint (TSP), or photogrammetry.

9. The schlieren imaging method of claim 1, wherein the imaging the twice-filtered light rays is performed using a color camera.

10. The schlieren imaging method of claim 1, wherein the imaging the twice-filtered light rays is performed using multiple monochrome cameras with a color filter positioned in front of the monochrome cameras.

11. The schlieren imaging method of claim 1, wherein projecting light rays with the first linear polarization includes projecting light rays from a light source and linearly polarizing the light rays with the first linear polarization, wherein the light source projects the light rays transverse to the optical axis, and the method further comprising projecting the light rays from the light source through a beam-splitter on the optical axis that redirects the light rays onto the optical axis.

12. A system for schlieren imaging a density object, comprising:
a light source assembly that projects light rays having a first linear polarization;
a grid that spectrally and spatially filters the light rays and is positioned on an optical axis;
a background that reflects the light rays and is positioned on the optical axis;
one or more optical elements that convert the light rays from the first linear polarization to a second linear polarization that is offset by 90 degrees from the first linear polarization, wherein the one or more linear polarization 90-degree offsetting optical elements are positioned on the optical axis between the grid and the background; and
a camera system that images the light rays and is positioned on the optical axis,
wherein in use the light rays are projected along the optical axis in a projected direction, spectrally and spatially filtered through the grid a first time, passed through the density object a first time, reflected off the background back along the optical axis in a reflected direction opposite the projected direction, passed through the density object a second time, spectrally and spatially filtered through the grid a second time, and incident on the camera system,
wherein in use the one or more linear polarization 90-degree offsetting optical elements convert the light rays from the first linear polarization to the second 90-degree offset linear polarization after the light rays are spectrally and spatially filtered through the grid the first time and before the light rays are spectrally and spatially filtered through the grid the second time so that the grid functions as a source grid and as a cut-off grid.

13. The schlieren imaging system of claim 12, wherein the grid comprises a one-dimensional spectral-spatial filter.

14. The schlieren imaging system of claim 12, wherein the grid is a Ronchi ruling grid having shortpass, longpass, bandpass, or notch filter lines.

15. The schlieren imaging system of claim 13, wherein the grid comprises a color photographic film material with an exposed image of the Ronchi ruling grid having one or two sets of shortpass, longpass, bandpass, or notch filter lines.

16. The schlieren imaging system of claim 12, wherein the grid comprises a two-dimensional spectral-spatial filter that is simultaneously sensitive to density gradients in two orthogonal directions.

17. The schlieren imaging system of claim 12, wherein the camera system comprises a color camera.

18. The schlieren imaging system of claim 12, wherein the camera system comprises multiple monochrome cameras with a color filter positioned in front of the monochrome cameras.

19. The schlieren imaging system of claim 12, wherein the light source projects the light rays transverse to the optical axis, the system further comprising a beam-splitter that is positioned on the optical axis and that redirects the light rays onto the optical axis.

20. The schlieren imaging system of claim 12, wherein the background is a retroreflective background.
